(19) United States
(12) Patent Application Publication
(10) Pub. No.: US 2013/0226611 A1
(43) Pub. Date: Aug. 29, 2013

(54) SIGNIFICANCE PARAMETER EXTRACTION METHOD AND ITS CLINICAL DECISION SUPPORT SYSTEM FOR DIFFERENTIAL DIAGNOSIS OF ABDOMINAL DISEASES BASED ON ENTROPY ROUGH APPROXIMATION TECHNOLOGY

(71) Applicants: Chang Sik Son, Daegu-si (KR); Yoon Nyun Kim, Daegu-si (KR); Hee Joon Park, Daegu-si (KR); Suk Tae Seo, Ulsan-si (KR); Min Soo Kim, Daegu-si (KR)

(72) Inventors: Chang Sik Son, Daegu-si (KR); Yoon Nyun Kim, Daegu-si (KR); Hee Joon Park, Daegu-si (KR); Suk Tae Seo, Ulsan-si (KR); Min Soo Kim, Daegu-si (KR)

(73) Assignee: Keimyung University Industry Academic Cooperation Foundation, Daegu-si (KR)

(21) Appl. No.: 13/882,500

(22) PCT Filed: Sep. 23, 2011
(86) PCT No.: PCT/KR2011/007016

§ 371 Date: Apr. 29, 2013

(30) Foreign Application Priority Data
Mar. 22, 2011 (KR) 1020110025461

(51) Int. Cl. G06Q 10/10; G06Q 50/22

(52) U.S. Cl. CPC G06Q 10/10; G06Q 50/22
USPC 705/2

(57) ABSTRACT

A significance parameter extraction method for differential diagnosis of abnormal diseases based on entropy rough approximation technology, including the steps of: (a) calculating clinical reference values from two different groups of clinical data extracted from a database storing a plurality of clinical data for each check item using an entropy maximization measure; (b) evaluating a clinical difference between the two different groups of clinical data and extracting candidate check items; (c) based on a reference value of a check item calculated from one of the groups of clinical data, converting attribute values of the check item into nominal attribute values; and (d) extracting significance parameters for differential diagnosis from the candidate check items extracted in the step (b).

### TECHNICAL FIELD

The present invention relates to a clinical data parameter extraction method and a clinical support system using the same, and more particularly, to a significance parameter extraction method for differential diagnosis based on an entropy rough approximation technology, and an integrated clinical decision support system using the same.

### BACKGROUND ART

There are different tools available for treatment with the knowledge of patients' conditions in the field of medicine. Traditionally, doctors check patients' conditions physically, identify problems and conditions of patients and decide proper treatment based on an extensive array of knowledge collected from researches of many years.

Traditionally, a source of support information includes other health professionals, reference books and manuals, relatively simple check results and analysis, etc. For the past ten years, particularly in recent years, a wide array of different reference substances is available for health professionals, expanding available resources and improving medical workers' diagnosis and nosotrophy.

Diagnosis resources available for doctors and other caregivers may include information databases in addition to resources which can be prescribed and controlled. This database is a typical reference library, which is known to be available from many sources, and provides doctors with detailed information on possible disease conditions, information on methods of identifying such conditions, and treatments of such conditions in a few second.

Of course, similar reference substances may be used to identify considerations such as interaction of medicines, tendency of disease and medical affairs, etc. Some of these reference substances may be provided for free to persons tending the sick, while some may involve subscription or joint membership.

There has also been known a particular data acquisition technique which can be specified and controlled to examine potential patient conditions and medical affairs and point out a source of potential medical problems. A traditional prescription data source includes a simple blood test, a urine test, a handwritten result of physical checks, etc. For decades before, more elaborated techniques have been developed, including various types of electrical data acquisitions for detecting and recording operation of a body system and responsiveness of a system to situations and stimuli to some degrees.

A more elaborated system has also been developed to provide an image of human body including internal characteristics which could be seen and analyzed only through an operation before development of this system and to view and analyze other characteristics and functions which could not be seen by other methods or systems. All these techniques were added to an extensive array of resources available for doctors, thereby greatly improving quality of medical treatment and nursing.

In spite of dramatic increase and improvement in a source of medical information, prescription and analysis of test and data and diagnosis and treatment of medical affairs still rely greatly on specialized knowledge of skilled persons tending the sick. Input and decision provided by person's experience will not and should not replace such situations. However, there is a need to further improve and integrate sources of medical information.

Attempts for automated notification of diagnosis and analysis have been made; however, such attempts could not approach a level of integration and correlation which is most useful for quick and efficient patient care. Applications are being increasingly developed to analyze medical data based on characteristics identification and classification algorithms.

### DISCLOSURE

### Technical Problem

However, such algorithms are limited in their current use due to their typical limited analysis and the limited amount of accessible information for analysis. Also, such algorithms are greatly limited by particular diseases and imaging modes. Such activity sometimes requires a particular program and project performed by a programmer based on periodical analysis of available data, which may result in difficulty in enhancement and improvement of the algorithms.

In addition, conventional algorithms or clinical diagnosis support programs provide diagnosis information of concerned diseases by utilizing symptom information on a medical examination by interview with patients and basic information corresponding to a related symptom, which may result in low precision and reliability of diagnosis information due to limitation of basic clinical information data.

In addition, conventional methods using a vast of clinical information data employ general statistical analysis methods. However, since such methods pass through a ‘data pre-process’ to remove check items having no clinical data (null values) or having unknown values or perform a process of replacing null values with a median values or a mean value, if a percentage of null values is large, there is a possibility of loss of the check item in the ‘data pre-process’ and there may occur a problem of distortion or low reliability of data by replacing a check item actually unchecked for a patient with a representative value.

### Technical Solution

To overcome the above problems, it is an object of the invention to provide an integrated clinical decision support system for differential diagnosis of similar diseases, which is capable of utilizing raw data of collected results of clinical checks without performing a ‘data pre-process’, which may cause a problem of distortion or low reliability of data, integrating a clinical decision model for a particular disease with a clinical decision model partially designed for similar diseases, and building a database for clinical knowledge.

To achieve the above object, according to a first aspect of the invention, there is provided a significance parameter extraction method for differential diagnosis of abnormal diseases based on entropy rough approximation technology, including the steps of: (a) calculating clinical reference values from two different groups of clinical data extracted from a database storing a plurality of clinical data for each check item using an entropy maximization measure; (b) evaluating a clinical difference between the two different groups of clinical data and extracting candidate check items; (c) based on a reference value of a check item calculated from one of the groups of clinical data, converting attribute values of the check item into nominal attribute values; and (d) extracting significance parameters for differential diagnosis from the candidate check items extracted in the step (b).

Preferably, the two different groups of clinical data include: a group having one disease and a group having another disease; or a group having one disease and a group having other diseases.

Preferably, the entropy maximization measure is calculated by:

$$Maximize to H ( T ) = {H}_{R 1} ( T ) + {H}_{R 2} ( T ) , \\ where {H}_{R 1} ( T ) = - {\sum }_{g = {a}_{min}}^{T} {P}_{R 1} ( g ) \cdot log {P}_{R 1} ( g ) , \\ {H}_{R 2} ( T ) = - {\sum }_{g = T + 1}^{{a}_{max}} {P}_{R 2} ( g ) \cdot log {P}_{R 2} ( g ) , \\ P ( g ) = {\sum }_{i = {a}_{min}}^{g} p ( i )$$

where, P(g) represents a cumulative probability value in a domain range, and H_{R1} (T) and H_{R2} (T) represent threshold values, that is, entropies of two regions R1 and R2 when a reference value of the corresponding check item is T, where H(T) represents the sum of entropies.

Preferably, the step (b) includes: in case of a single reference value, extracting cases where reference values of the two different groups of clinical data for one check item are different, as candidate check items; and in case of two reference values, extracting cases where one range of reference values is not included in another range of reference values, as candidate check items.

Preferably, the step (c) includes: in case of a single reference value, converting values of check items of two regions into nominal values based on the single reference value; and in case of two reference values, converting values of check items of three regions into nominal values based on the two reference values.

Preferably, the step (d) includes the steps of: generating a decision table to be converted into the extracted candidate check items and the nominal values for each check item; generating a discernibility matrix based on the decision table; and extracting significance parameters for differential diagnosis by calculating a discernibility function from the discernibility matrix.

Preferably, the discernibility matrix is generated by:

(cᵢⱼ)={aεA:a(xᵢ)≠z(xⱼ)},∃i,j, for dᵢ≠dⱼ

where, A means the total set of input variables representing check items, and a means any element in the total set of input variables, xᵢ represents an i-th case, dᵢ represents an i-th output attribute value indicating a disease, cᵢⱼ means input variables having a difference in attribute value between two different cases, and N represents the total number of cases.

Preferably, the discernibility function is expressed by:

$$f ( A ) = {\prod }_{( x , y ) ∈ {U}^{2}} ( \sum δ ( x , y ) : ( x , y ) ∈ {U}^{2} and δ ( x , y ) \neq φ )$$

where, Σδ(x,y) means an OR operation between attribute values included in (x,y) elements,

$${\prod }_{( x , y ) ∈ {U}^{2}} ( \cdot )$$

and means an AND operation between different elements in a corresponding case.

Preferably, at least one nominal value in the decision table is null, and unknown values can have all corresponding values.

According to a second aspect of the invention, there is provided an integrated clinical decision support system including: a clinical information database including clinical data for each of a plurality of check items; a database which stores disease information defined by clinical specialists from the clinical data; a clinical decision support module which uses the above-described method; a knowledge database which stores temporary knowledge generated from the clinical decision support module, including clinical decision support information; and an application interface module which acquires clinical decision support synthetic information generated through the knowledge database.

Preferably, the integrated clinical decision support system further includes a core knowledge repository database which stores the information generated in the clinical decision support module and core knowledge obtained based on clinical information decided by clinical specialists.

Preferably, the clinical decision support module includes a significance parameter extraction module using a method according to any one of claims 1 to 9, and a clinical decision model design module.

Preferably, the clinical decision model design module is designed to have a tree structure with application of all check items, which are determined by one reference value or two reference values applied to the significance parameter extraction method, to N groups of experiments and controls data collected by N random samplings from the clinical information database.

### Advantageous Effects

The significance parameter extraction method of this invention has an advantage of utilization of raw data of collected results of clinical checks without performing a data pre-process, thereby allowing use of this method in a variety of application fields.

In addition, the integrated clinical decision support system using the extraction method for differential diagnosis of similar diseases is capable of integrating a clinical decision model for a particular disease with a clinical decision model partially designed for similar diseases, and building a database for clinical knowledge.

In addition, the integrated clinical decision support system can be effectively used to create education and learning contents for interns and residents for each department in a hospital.

### DESCRIPTION OF DRAWINGS

FIG. 1 is a flow diagram of a significance parameter extraction method for entropy rough approximation technology-based disease differential diagnosis according to an embodiment of the present invention.

FIG. 2 is a view showing results of check of a group of heart failure patients and a group of non-cardiac dyspneic patients for a check item ‘Total Bilirubin’ [mg/dL] of basic check items for inpatients for application of a significance parameter extraction method to entropy rough approximation technology-based disease differential diagnosis according to an embodiment of the present invention.

FIG. 3 is a graph showing reference values of the check item ‘Total Bilirubin’ determined by an entropy maximization measure applied to the present invention.

FIG. 4 is a schematic view showing a nominal conversion process as a step of the significance parameter extraction method according to an embodiment of the present invention.

FIG. 5 is a view showing a configuration of an integrated clinical decision support system according to another embodiment of the present invention.

FIG. 6 is a model view showing an example of a decision model applied to the integrated clinical decision support system of the present invention and a conventional decision model.

### BEST MODE

Hereinafter, preferred embodiments of the present invention will be described in detail with reference to the drawings.

Differential diagnosis is a diagnosis which compares and reviews between a disease thought out from a characteristic of a symptom and other considered diseases having similar characteristics and detects whether or not the considered diseases are equal to the initially thought disease. For example, if the initially through disease is thought of as pneumonia based on symptoms such as high fever, chest pain, cough, phlegm, etc., consultation opinion, clinical check opinion and so on, diseases, such as influenza, acute bronchitis, acute tuberculosis, pleurisy and so on, having similar characteristics may be concerned in differential diagnosis.

However, these diseases are different from pneumonia since they have different characteristics in status of pathogenesis and progress, presence of morbid change of a lung, X-ray opinion, bacteriological check opinion and so on although they have the same characteristic as pneumonia. Therefore, the present invention suggests a significance parameter extraction method for differential diagnosis which is very important and difficult in the clinical aspect, and a clinical decision support system using the same.

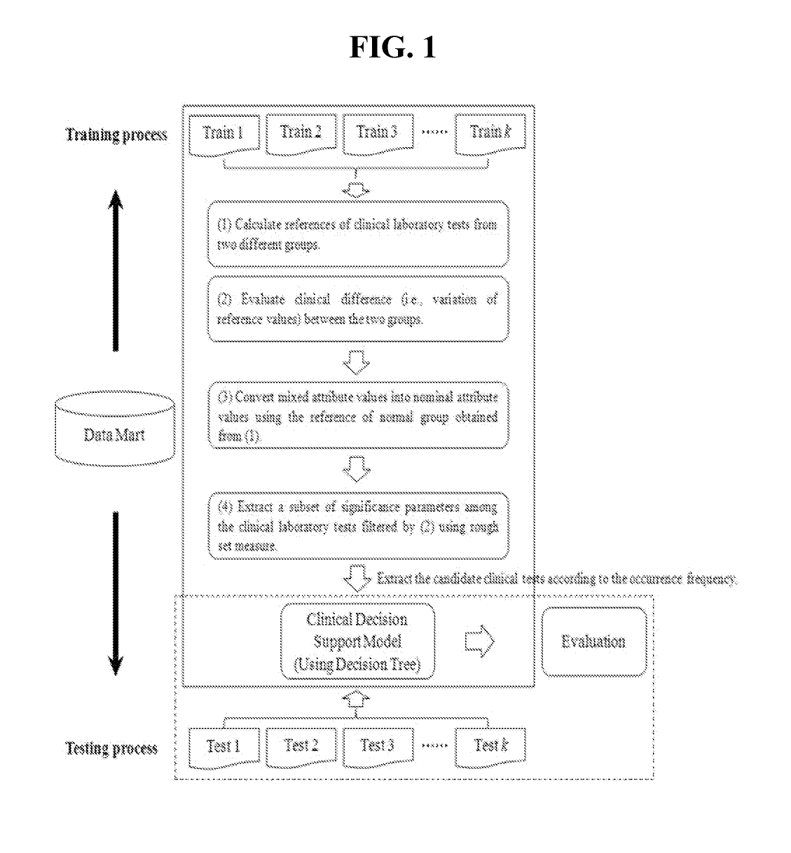

FIG. 1 is a flow diagram of a significance parameter extraction method for entropy rough approximation technology-based disease differential diagnosis according to an embodiment of the present invention. As shown in FIG. 1, the significance parameter extraction method of this invention includes the steps of: (a) calculating clinical reference values from two different groups of clinical data extracted from a database storing a plurality of clinical data for each check item using an entropy maximization measure (S100); (b) evaluating a clinical difference between the two different groups of clinical data and extracting candidate check items (S200); (c) based on a reference value of a check item calculated from one of the groups of clinical data, converting attribute values of the check item into nominal attribute values (S300); and (d) extracting significance parameters for differential diagnosis from the candidate check items extracted in the step (b) (S400).

First, reference values of clinical laboratory tests are calculated from two different groups of clinical data extracted from a database storing a plurality of clinical data for each check item using an entropy maximization measure (S100).

Here, the ‘two different groups’ may be a disease A and a disease B or an abnormal group having the disease A and a normal group having no disease or other disease. That is, the two different groups may be clinical data of patients having different diseases and may be divided into an abnormal group having any disease and a normal group having no disease.

For example, “Data Mart” (a clinical database storing diseases defined by clinical specialists) extracted from a hospital information system (HIS) may consist of a group of patients (I50) having a particular disease, for example, an acute heart failure and a group of non-cardiac dyspneic patients (No) which do not exhibit a clinical opinion of heart failure although they visit to hospital for a symptom of dyspnea. Here, I50 refers to a disease classification code specified by ‘International Classification of Diseases (ICD)-10’ where ‘group of non-cardiac dyspneic patients’ is marked with ‘No’ as it is not classified into a particular disease. In addition, “Data Mart” extracted from HIS is defined by the following clinical check items: CBC & Differential Count; Prothrombin Time (PT); Activated Partial Thromboplastin Time (APTT); Serum Electrolytes; Rountine Admission; Amylase; Blood pH and Gas; Lipase; CK-MB; Troponin-I; CK; LDH; CRP; Fibrinogen; Ca²⁺; Mg²⁺; Pro BNP; etc.

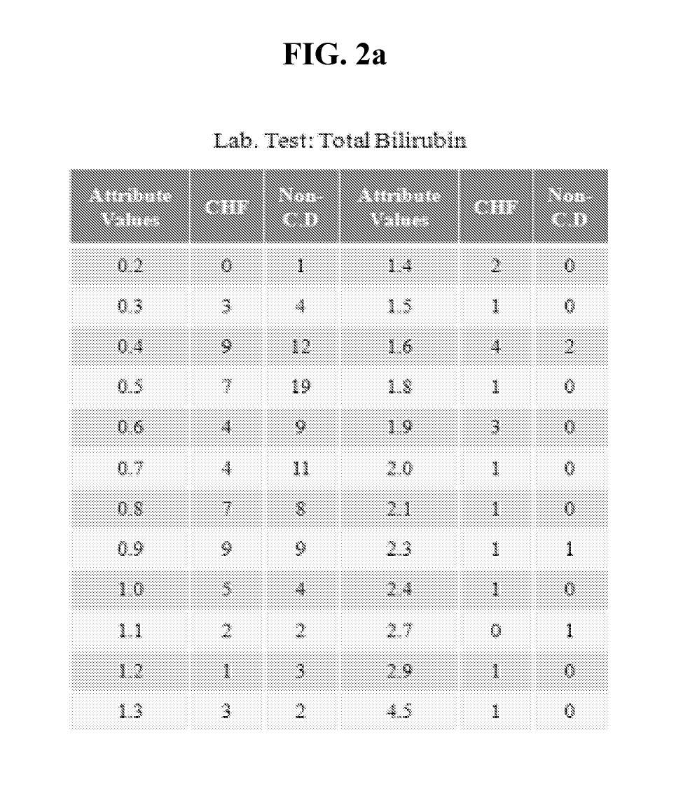

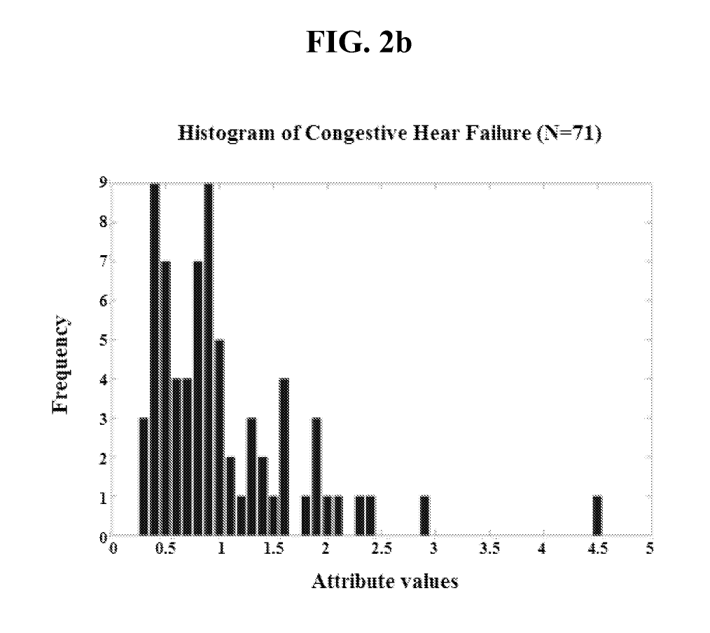

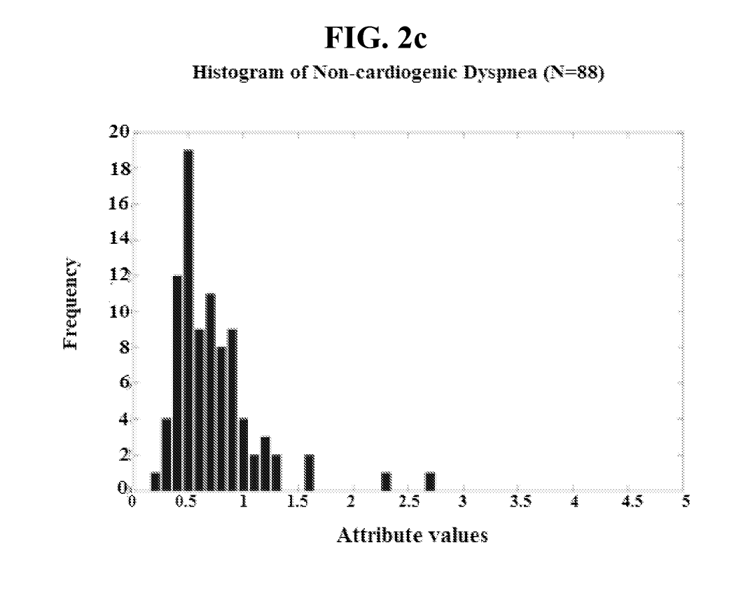

FIG. 2 is a view showing results of check of a group of heart failure patients and a group of non-cardiac dyspneic patients for a check item ‘Total Bilirubin’ [mg/dL] of basic check items for inpatients for application of a significance parameter extraction method to entropy rough approximation technology-based disease differential diagnosis according to an embodiment of the present invention.

FIG. 2(a) is a table showing results of check of a check item ‘Total Bilirubin’, FIG. 2(b) is a graph showing a frequency distribution of the check results of Total Bilirubin for patients suffering from heart failure, and FIG. 2(c) is a graph showing a frequency distribution of the check results of Total Bilirubin for a group of non-cardiac dyspneic patients.

In FIG. 2(a), ‘Attribute values’ represent result values of the check item ‘Total Bilirubin’, ‘CHF’ represents a group of patients suffering from congestive heart failure where a value of each row means the number of patients having the corresponding attribute value, and ‘Non-C.D’ represents a group of non-cardiac dyspneic patients where a value of each row means the number of patients having the corresponding attribute value.

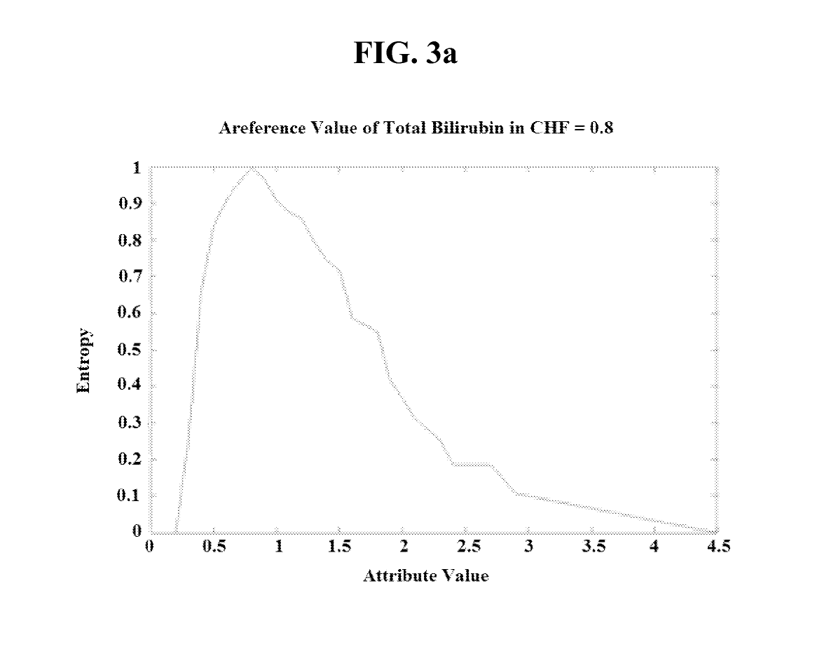

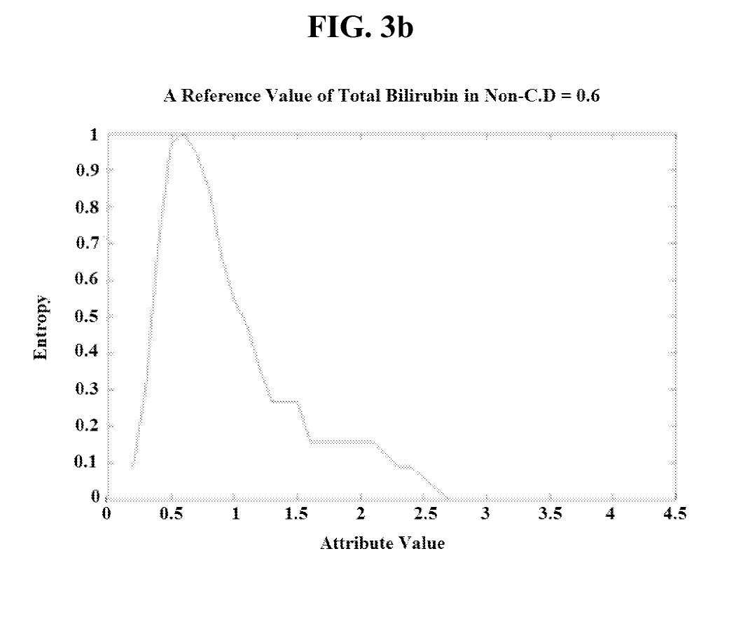

In addition, FIGS. 2(b) and 2(c) show a distribution of patients having the corresponding attribute value from the group of congestive heart failure patients and a distribution of patients having the corresponding attribute value from the group of non-cardiac dyspneic patients, respectively. Based on the distributions of FIGS. 2(b) and (c), results of calculation of clinical reference values of each group for the check item ‘Total Bilirubin’ using the entropy maximization measure may be shown in FIG. 3 which is a graph showing reference values of the check item ‘Total Bilirubin’ determined by the entropy maximization measure applied to the present invention.

The following Equation 1 represents an entropy maximization measure applied to the significance parameter extraction method according to an embodiment of the present invention.

$$Maximize to H ( T ) = {H}_{R 1} ( T ) + {H}_{R 2} ( T ) , \\ where {H}_{R 1} ( T ) = - {\sum }_{g = {a}_{min}}^{T} {P}_{R 1} ( g ) \cdot log {P}_{R 1} ( g ) , \\ {H}_{R 2} ( T ) = - {\sum }_{g = T + 1}^{{a}_{max}} {P}_{R 2} ( g ) \cdot log {P}_{R 2} ( g ) , \\ P ( g ) = {\sum }_{i = {a}_{min}}^{g} p ( i ) \qquad [ Equation 1 ]$$

Where, when a domain range of a corresponding check item is aₘᵢₙ to aₘₐₓ (that is, 0.2 to 4.5 in FIG. 2(a)), P(g) represents a cumulative probability value from the minimum value 0.2 to g in the domain range, and H_{R1} (T) and H_{R2} (T) represent threshold values, that is, entropies of two regions R1 and R2 when a reference value of the corresponding check item is T, where H(T) represents the sum of entropies and a threshold value having the maximum entropy value when a value g of the check item is varied from aₘᵢₙ to aₘₐₓ becomes a reference value of the check item.

Reference values of the group of congestive heart failure patients and the group of non-cardiac dyspneic patients in the check item ‘Total Bilirubin’ determined in this manner are as shown in FIGS. 3(a) and 3(b). FIG. 3(a) shows a reference value of Total Bilirubin in the group of congestive heart failure patients and a reference value of Total Bilirubin in the group of non-cardiac dyspneic patients.

In FIGS. 3(a) and 3(b), the clinical reference values of Total Bilirubin in the group of congestive heart failure patients and the group of non-cardiac dyspneic patients are 0.8 and 0.6, respectively, from which it can be seen that the reference value of the group of congestive heart failure patients is larger than the reference value of the group of non-cardiac dyspneic patients.

In the present invention, one clinical reference value T and two reference values T₁ and T₂ for each check item are extracted because one reference value of a clinical check item is present in particular check items and two reference values are present in other most check items in the clinical aspect. If two reference values of a corresponding check item are determined, the entropy maximization measure has to be divided into three regions H_{R1}, H_{R2} and H_{R3} in Equation 1.

The second step is to evaluate a clinical difference (i.e., variation of reference values) between the two different groups of clinical data <reference value evaluation process> (S200). In a case of a single reference value of clinical check is present, assuming that the reference value CHF of the group of congestive heart failure patients for the check item ‘Total Bilirubin’ is a and the reference value Non-C.D of the group of non-cardiac dyspneic patients is β, if α=β, the check item ‘Total Bilirubin’ is removed since it has no difference between these two groups of patients; otherwise, if α≠β, this check item is left as a candidate check item for differential diagnosis.

In the case of two reference values of clinical check, similarly, assuming that the reference value CHF of the group of congestive heart failure patients is [α,β] (aₘᵢₙ≦α≦β≦aₘₐₓ) and the reference value Non-C.D of the group of non-cardiac dyspneic patients is [γ,δ] (aₘᵢₙ≦γ≦δ≦aₘₐₓ), if these conditions are satisfied, in other words, if the lower and upper limits of the reference value of the group of congestive heart failure patients are included in the range of the lower and upper limits of the reference value of the group of non-cardiac dyspneic patients, the check item ‘Total Bilirubin’ is removed; otherwise, this check item is left as a candidate check item for differential diagnosis.

In this manner, in this invention, all possible candidate check items when one or two reference values of clinical check are present are extracted. This correspond to the “entropy maximization measure” (first filtering process) representing the step (1) and the step (2) of the significance parameter extraction method of this invention in FIG. 2.

The third step is to convert attribute values of a corresponding check item into nominal attribute values, based on calculated reference values of each check item of the normal group (S300).

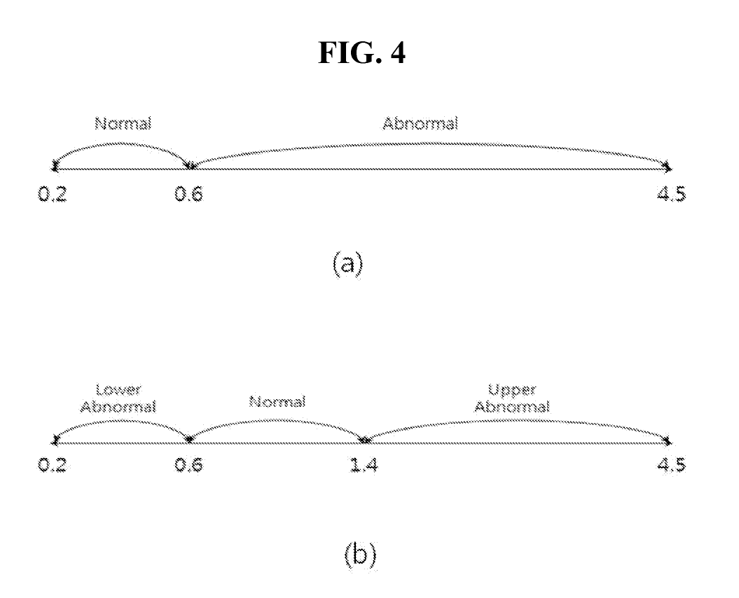

FIG. 4 is a schematic view showing a nominal conversion process as a step of the significance parameter extraction method according to an embodiment of the present invention. FIG. 4(a) is a schematic view of a check item nominal attribute value conversion process for one reference value of clinical check and FIG. 4(b) is a schematic view of a check item nominal attribute value conversion process for two reference values of clinical check.

As shown in FIG. 4, if the reference value of clinical check is determined as one value (0.6), the corresponding check value is divided into two partial normal and abnormal spaces based on the determined reference value and values of the check item is modified to normal and abnormal (FIG. 4(a)).

Similarly, if the two reference values in the check item ‘Total Bilirubin’ for the group of non-cardiac dyspneic patients are determined as, two value {0.6 and 1.4}, respectively, the corresponding check item is divided into three partial spaces, such as lower normal of a range of 0.2 to 0.6, normal of a range of 0.6 to 1.4 and upper abnormal of a range of 1.4 to 4.5, and then values of the check item are made nominal (FIG. 4(b)).

The fourth step is to extract significance parameters for differential diagnosis from the candidate check items extracted or filtered in the second step using approximation measure of a rough set (S400).

The candidate check items extracted in the second step and a decision table having conversion of nominal values at this time are assumed as follows:

TABLE 1

| | Input variable | | | | | |
|---|---|---|---|---|---|---|
| Case | WBC | RBC | Total Bilirubin | Troponin I | Pro BNP | Output variable |
| 1 | U_abnormal | U_abnormal | U_abnormal | L_abnormal | Normal | I50 |
| 2 | U_abnormal | — | U_abnormal | U_abnormal | U_abnormal | I50 |
| 3 | Normal | Normal | L_abnormal | L_abnormal | — | No |
| 4 | Normal | Normal | U_abnormal | — | — | I50 |
| 5 | — | — | — | U_abnormal | Normal | No |
| 6 | Normal | Normal | — | — | Normal | No |

In Table 1, WBC (White Blood Cell), RBC (Red Blood Cell), Total Bilirubin, Troponin I and Pro BNP are input variables, that is, check items, and ‘Output variable’ represents the group of congestive heart failure (CHF) patients and the group of non-cardiac dyspneic patients (No).

In the input variables WBC, RBC, Total Bilirubin, Troponin I and Pro BNP, ‘U_abnormal’ and ‘L_abnormal’ mean upper abnormal and lower abnormal, respectively (see FIG. 4). In addition, in Cases 2 to 6, ‘−’ represents null values or unknown values which mean unchecked clinical check items. In other words, these null or unknown values always exist since most patients have only necessary clinical checks in a concerned department of treatment in a visiting hospital.

Based on the decision table of Table 1, a discernibility matrix is constructed using the following Equation 2.

(cᵢⱼ)=aεA:a(xᵢ)≠a(xⱼ),∃i,j, for dᵢ≠dⱼ [Equation 2]

Where, A means the total set of input variables {WBC, RBC, Total Bilirubin, Troponin I, Pro BNP} in Table 1, and a means any element in the total set of input variables. xᵢ and xⱼ represent i-th and j-th cases, respectively, and dᵢ and dⱼ represent i-th and j-th output attribute values (i.e., I50 or No), respectively.

In Equation 2, {aεA:a(xᵢ)≠a(xⱼ)} means variables (i.e., attributes) having different values in the i-th and j-th cases if a is WBC. Accordingly, cᵢⱼ (i, j=1, 2, . . . , N) means input variables having a difference in attribute value between the two different cases, where N represents the total number of cases.

In this invention, in order to use ‘−’ representing the null or unknown values without performing any statistical pre-process, it is defined by a ‘don't care’ condition. (Where, the ‘don't care’ condition means that a corresponding null or unknown value can have all possible corresponding values.)

In other words, in general, if a percentage of null values of a corresponding check item in differential diagnosis of a particular disease is large, there is a possibility of loss of the check item in a ‘data pre-process’ and there may occur a problem of distortion or low reliability of data by replacing a check item actually unchecked for a patient with a representative value. Accordingly, this process has an advantage of utilization of raw data of collected results of clinical checks without performing the ‘data pre-process’, thereby allowing use of this process in a variety of application fields.

TABLE 2

| Case | 1 | 2 | 3 | 4 | 5 | 6 |
|---|---|---|---|---|---|---|
| 1 | | | WBC, RBC, | | Troponin I | WBC, RBC |
| | | | Total Bilirubin | | | |
| 2 | | | WBC, Total | | Pro BNP | WBC, Pro BNP |
| | | | Bilirubin, | | | |
| | | | Troponin I | | | |
| 3 | WBC, RBC, | WBC, Total | | Total | | |
| | Total | Bilirubin, | | Bilirubin | | |
| | Bilirubin | Troponin I | | | | |
| 4 | | | Total Bilirubin | | | |
| 5 | Troponin I | Pro BNP | | | | |
| 6 | WBC, RBC | WBC, Pro | | | | |
| | | BNP | | | | |

According to the definition of the discernibility matrix in Equation 2, cᵢⱼ is formed with a 6×6 matrix since the total number of cases is 6 (see Table 1), an upper triangular matrix and a lower triangular matrix have a symmetrical structure with respect to a diagonal matrix {(1,1), (2,2), (3,3), (4,4), (5,5), (6,6)}, and blanks (□) have same output attribute values (i.e., comparison between I50 and No) or nominal values of same input variables for different output attribute values.

In other words, the same output attribute values correspond to a matrix {(1,2), (1,4), (2,4), (2,1), (4,1), (4,2)} and a matrix {(3,5), (3,6), (5,6), (5,3), (6,3), (6,5)} in addition to the diagonal matrix, and the same input variable values for different output attribute values correspond to a matrix {(4,5), (4,6), (5,4), (6,4)}.

From the discernibility matrix of Table 2, a discernibility matrix for the entire cases is calculated according to the following Equation 3 and significance parameters (i.e., a list of significance check items) for differential diagnosis are extracted.

$$f ( A ) = {\prod }_{( x , y ) ∈ {U}^{2}} ( \sum δ ( x , y ) : ( x , y ) ∈ {U}^{2} and δ ( x , y ) \neq φ ) \qquad [ Equation 3 ]$$

Where, δ(x,y)≠φ means entire elements except blanks (□) in the discernibility matrix of Table 2, Σδ(x,y) means an ‘OR’ operation between attribute values included in (x,y) elements, and

$${\prod }_{( x , y ) ∈ {U}^{2}} ( \cdot )$$

means an ‘AND’ operation between different elements in a corresponding case. This is equivalent to expression of the discernibility matrix as a conjunctive normal form in Boolean algebra.

The following discernibility matrix f(A) may be constructed from the discernibility matrix of Table 2 and a simplified final equation can be derived using two laws of Boolean algebra, that is, a distributive law and an absorptive law.

f(A)=(WBC+RBC+Total Bilirubin)*Troponin I*(WBC+RBC)*(WBC+Total Bilirubin+Troponin I)*Pro BNP*(WBC+Pro BNP)*Total Bilirubin

=(WBC+RBC)*Troponin I*Pro BNP*Total Bilirubin

=WBC*Total Bilirubin*Troponin I*Pro BNP+RBC*Total Bilirubin*Troponin I*Pro BNP

(WBC+RBC+Total Bilirubin)*(WBC+RBC)=(WBC+RBC)<=absorptive law a)

(WBC+Total Bilirubin+Troponin I)*Troponin I=Troponin I<=absorptive law b)

(WBC+Pro BNP)*Pro BNP=Pro BNP<=absorptive law=A c)

Accordingly, it can be seen that the discernibility matrix f(A) is finally simplified as WBC*Total Bilirubin*Troponin I*Pro BNP+RBC*Total Bilirubin*Troponin I*Pro BNP, from which two types of significance parameters (i.e., a list of significance check items) for differential diagnosis can be derived.

\textcircled{1} First significance parameters: {WBC, Total Bilirubin, Troponin I, Pro BNP}

\textcircled{2} Second significance parameters: {RBC, Total Bilirubin, Troponin I, Pro BNP}

It can be seen that “Total Bilirubin, Troponin I and Pro BNP” in the two sets of significance parameters are indispensable check items for differential diagnosis of the group of congestive heart failure patients and the group of non-cardiac dyspneic patients.

Accordingly, in this invention, a set of final significance check items is selected by extracting one set of significance parameters having the minimal parameter length. In addition, as in the above example, in the case of two or more significance parameters having the same parameter length, final significance check items may be selected by selecting any set of significance parameters.

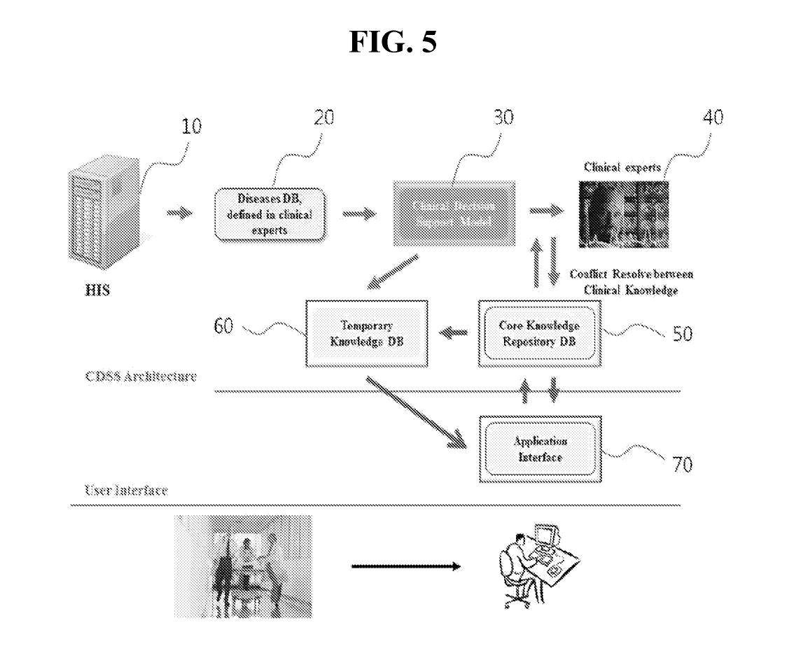

FIG. 5 is a view showing a configuration of an integrated clinical decision support system according to another embodiment of the present invention. As shown in FIG. 5, a clinical decision support system of this invention includes a clinical information database 10 including clinical data for each of a plurality of check items extracted from the hospital information system (HIS); a database 20 which stores disease information defined by clinical specialists from the clinical data; a clinical decision support module 30 which uses a significance parameter extraction method for the above-described entropy rough approximation technology-based disease differential diagnosis; a knowledge database 60 which stores temporary knowledge generated from the clinical decision support module 30, including clinical decision support information; and an application interface module 70 which acquires clinical decision support synthetic information generated through the knowledge database.

Here, the clinical decision support module includes a decision support model. In this embodiment, a design method of a decision support model of a group of congestive heart failure patients will be described below (object: group of congestive heart failure patients vs. group of non-cardiac dyspneic patients).

The following Table 3 shows basic clinical characteristics (72 clinical check items) of the group of congestive heart failure patients and the group of non-cardiac dyspneic patients.

TABLE 3

| Variables +Z,38 | CHF (N = 71) +Z,38 | Non-C.D (N = 88) +Z,38 | P value +Z,38 |
|---|---|---|---|
| Age, (yrs) +Z,38 | 73.39 ± 9.86 +Z,38 | 65.23 ± 15.14 +Z,38 | <0.000 +Z,38 |
| Gender, n (%) +Z,38 | M: 26 (36.6); F: 45(63.4) +Z,38 | M: 49 (55.7); F: 39 (44.3) +Z,38 | <0.017 +Z,38 |
| Urinary tests +Z,38 | +Z,38 | +Z,38 | +Z,38 |
| Color, n (%) +Z,38 | Amber: 3 (4.2); Straw: 68 (95.8) +Z,38 | Amber: 3 (3.4); Straw: 85 (96.6) +Z,38 | 0.798 +Z,38 |
| S.G., +Z,38 | 1.02 ± 0.01 +Z,38 | 1.02 ± 0.01 +Z,38 | 0.719 +Z,38 |
| pH, +Z,38 | 6.08 ± 0.94 +Z,38 | 6.34 ± 0.87 +Z,38 | 0.080 +Z,38 |
| Albumin, n (%) +Z,38 | Neg.: 45 (63.4); Pos.: 26 (36.6) +Z,38 | Neg.: 68 (77.3); Pos.: 20 (22.7) +Z,38 | 0.055 +Z,38 |
| Glucose, n (%) +Z,38 | Neg.: 55 (77.5); Pos.: 16 (22.5) +Z,38 | Neg.: 64 (72.7); Pos.: 24 (27.3) +Z,38 | 0.494 +Z,38 |
| Ketone, n (%) +Z,38 | Neg.: 65 (91.5); Pos.: 6 (8.5) +Z,38 | Neg.: 79 (89.8); Pos.: 9 (10.2) +Z,38 | 0.703 +Z,38 |
| O.B., n (%) +Z,38 | Neg.: 33 (46.5); Pos.: 38 (53.5) +Z,38 | Neg.: 55 (62.5); Pos.: 33 (37.5) +Z,38 | <0.043 +Z,38 |
| Urobilinogen, +Z,38 | 0.30 ± 0.80 +Z,38 | 0.40 ± 1.16 +Z,38 | 0.545 +Z,38 |
| Bilirubin, n (%) +Z,38 | Neg.: 66 (93.0); Pos.: 5 (7.0) +Z,38 | Neg.: 82 (93.2); Pos.: 6 (6.8) +Z,38 | 0.956 +Z,38 |
| Nitrite, n (%) +Z,38 | Neg.: 67 (94.4); Pos.: 4 (5.6) +Z,38 | Neg.: 85 (96.6); Pos.: 3 (3.4) +Z,38 | 0.497 +Z,38 |
| WBC1, n (%) +Z,38 | Neg.: 51 (71.8); Pos.: 20 (28.2) +Z,38 | Neg.: 72 (31.8); Pos.: 16 (18.2) +Z,38 | 0.135 +Z,38 |
| RBC, n (%) +Z,38 | Neg.: 13 (18.3); Pos.: 58 (81.7) +Z,38 | Neg.: 34 (38.6); Pos.: 54 (61.4) +Z,38 | <0.005 +Z,38 |
| WBC2, n (%) +Z,38 | Neg.: 3 (4.2); Pos.: 63 (95.8) +Z,38 | Neg.: 9 (10.2); Pos.: 79 (89.8) +Z,38 | 0.154 +Z,38 |
| Ep. Cell, n (%) +Z,38 | Neg.: 16 (22.5); Pos.: 55 (77.5) +Z,38 | Neg.: 19 (21.6); Pos.: 69 (78.4) +Z,38 | 0.886 +Z,38 |
| Cast, n (%) +Z,38 | Neg.: 71 (100.0); Pos.: 0 (0.0) +Z,38 | Neg.: 88 (100.0); Pos.: 0 (0.0) +Z,38 | — +Z,38 |
| Other, n (%) +Z,38 | Neg.: 67 (94.4); Pos.: 4 (5.6) +Z,38 | Neg.: 84 (95.5); Pos.: 4 (4.5) +Z,38 | 0.755 +Z,38 |
| Crystal, n (%) +Z,38 | Neg.: 71 (100.0); Pos.: 0 (0.0) +Z,38 | Neg.: 37 (98.9); Pos.: 1 (1.1) +Z,38 | 0.368 +Z,38 |
| CBC +Z,38 | +Z,38 | +Z,38 | +Z,38 |
| WBC, ×10³/μL +Z,38 | 9.12 ± 3.62 +Z,38 | 9.42 ± 4.12 +Z,38 | 0.633 +Z,38 |
| RBC, ×10³/μL +Z,38 | 3.98 ± 0.63 +Z,38 | 4.21 ± 0.63 +Z,38 | <0.025 +Z,38 |
| HGB, g/dL +Z,38 | 12.16 ± 2.19 +Z,38 | 12.87 ± 2.01 +Z,38 | <0.036 +Z,38 |
| HCT, % +Z,38 | 36.31 ± 6.41 +Z,38 | 37.53 ± 5.58 +Z,38 | 0.210 +Z,38 |
| MCV, fl +Z,38 | 91.23 ± 5.88 +Z,38 | 39.34 ± 5.50 +Z,38 | <0.040 +Z,38 |
| MCH, [symbol] g +Z,38 | 30.67 ± 2.42 +Z,38 | 30.79 ± 2.12 +Z,38 | 0.745 +Z,38 |
| MCHC, g/dL +Z,38 | 33.73 ± 1.31 +Z,38 | 34.52 ± 1.18 +Z,38 | <0.000 +Z,38 |
| PLT,. ×10³/μL +Z,38 | 255.39 ± 109.83 +Z,38 | 281.06 ± 103.03 +Z,38 | 0.134 +Z,38 |
| NEUT, % +Z,38 | 73.08 ± 11.77 +Z,38 | 71.96 ± 14.43 +Z,38 | 0.600 +Z,38 |
| LYMP, % +Z,38 | 20.00 ± 11.10 +Z,38 | 19.38 ± 12.93 +Z,38 | 0.745 +Z,38 |
| MONO, % +Z,38 | 5.14 ± 2.33 +Z,38 | 5.32 ± 2.27 +Z,38 | 0.627 +Z,38 |
| EOS, % +Z,38 | 2.80 ± 3.57 +Z,38 | 2.91 ± 3.52 +Z,38 | 0.845 +Z,38 |
| BASO, % +Z,38 | 0.57 ± 0.33 +Z,38 | 0.54 ± 0.38 +Z,38 | 0.684 +Z,38 |
| LUC, % +Z,38 | 1.85 ± 0.89 +Z,38 | 1.67 ± 0.76 +Z,38 | 0.170 +Z,38 |
| MPV, fl +Z,38 | 8.43 ± 1.05 +Z,38 | 7.89 ± 0.80 +Z,38 | <0.000 +Z,38 |
| APTT, sec +Z,38 | 32.05 ± 8.66 +Z,38 | 29.25 ± 5.28 +Z,38 | <0.019 +Z,38 |
| PT1, sec +Z,38 | 1.19 ± 0.35 +Z,38 | 1.05 ± 0.22 +Z,38 | <0.003 +Z,38 |
| PT2, sec +Z,38 | 13.45 ± 3.96 +Z,38 | 11.91 ± 2.41 +Z,38 | <0.003 +Z,38 |
| Fibrinogen, +Z,38 | 348.25 ± 90.68 +Z,38 | 379.71 ± 111.72 +Z,38 | 0.057 +Z,38 |
| Serum Electrolytes +Z,38 | +Z,38 | +Z,38 | +Z,38 |
| Na, mmol/L +Z,38 | 142.61 ± 6.02 +Z,38 | 142.72 ± 4.88 +Z,38 | 0.901 +Z,38 |
| K, mmol/L +Z,38 | 4.75 ± 0.93 +Z,38 | 4.36 ± 0.57 +Z,38 | <0.002 +Z,38 |
| Cl mmol/L +Z,38 | 105.62 ± 7.48 +Z,38 | 105.30 ± 5.18 +Z,38 | 0.748 +Z,38 |
| LDH, U/L +Z,38 | 740.87 ± 466.11 +Z,38 | 571.55 ± 172.63 +Z,38 | <0.002 +Z,38 |
| Linase, U/L +Z,38 | 31.97 ± 17.47 +Z,38 | 30.52 ± 16.53 +Z,38 | 0.595 +Z,38 |
| CK, +Z,38 | 163.55 ± 150.15 +Z,38 | 201.83 ± 283.56 +Z,38 | 0.277 +Z,38 |
| CK-MB, +Z,38 | 3.67 ± 4.78 +Z,38 | 2.43 ± 3.53 +Z,38 | 0.071 +Z,38 |
| Amylase, U/L +Z,38 | 50.10 ± 27.52 +Z,38 | 47.98 ± 21.36 +Z,38 | 0.595 +Z,38 |
| Routine Admission +Z,38 | +Z,38 | +Z,38 | +Z,38 |
| Calcium, mg/dL +Z,38 | 8.74 + 0.60 +Z,38 | 8.90 ± 0.67 +Z,38 | 0.113 +Z,38 |
| Inorg. Phos., mg/dL +Z,38 | 4.08 ± 1.19 +Z,38 | 3.34 ± 0.82 +Z,38 | <0.000 +Z,38 |
| Glucose, mg/dL +Z,38 | 174.38 ± 78.27 +Z,38 | 156.08 ± 60.56 +Z,38 | 0.108 +Z,38 |
| BUN, mg/dL +Z,38 | 30.83 ± 21.37 +Z,38 | 19.60 ± 13.53 +Z,38 | <0.000 +Z,38 |
| Creatine, mg/dL +Z,38 | 1.62 ± 1.07 +Z,38 | 1.14 ± 0.72 +Z,38 | <0.001 +Z,38 |
| Cholesterol, mg/dL +Z,38 | 172.61 ± 48.65 +Z,38 | 168.66 ± 43.71 +Z,38 | 0.596 +Z,38 |
| Protein, g/dL +Z,38 | 6.85 ± 0.69 +Z,38 | 6.91 ± 0.72 +Z,38 | 0.630 +Z,38 |
| Albumin, g/dL +Z,38 | 3.82 ± 0.36 +Z,38 | 3.89 ± 0.44 +Z,38 | 0.327 +Z,38 |
| Bilirubin(T), mg/dL +Z,38 | 1.04 ± 0.71 +Z,38 | 0.73 ± 0.39 +Z,38 | <0.001 +Z,38 |
| Bilirubin(D), mg/dL +Z,38 | 0.37 ± 0.25 +Z,38 | 0.26 + 0.17 +Z,38 | <0.002 +Z,38 |
| ALP, U/L +Z,38 | 100.24 ± 31.94 +Z,38 | 94.74 ± 47.48 +Z,38 | 0.386 +Z,38 |
| AST, U/L +Z,38 | 106.80 ± 231.56 +Z,38 | 41.33 ± 67.67 +Z,38 | <0.013 +Z,38 |
| ALT, U/L +Z,38 | 71.58 ± 152.29 +Z,38 | 30.52 ± 30.66 +Z,38 | <0.015 +Z,38 |
| Ca²⁺, mEq/L +Z,38 | 2.25 ± 0.15 +Z,38 | 2.29 ± 0.16 +Z,38 | 0.061 +Z,38 |
| Mg²⁺, mg/dL +Z,38 | 2.33 ± 0.35 +Z,38 | 2.16 ± 0.30 +Z,38 | <0.002 +Z,38 |
| ABGA +Z,38 | +Z,38 | +Z,38 | +Z,38 |
| pH, +Z,38 | 7.46 ± 0.06 +Z,38 | 7.46 ± 0.07 +Z,38 | 0.977 +Z,38 |
| pCO2, mmHg +Z,38 | 38.47 ± 13.29 +Z,38 | 38.56 ± 10.68 +Z,38 | 0.963 +Z,38 |
| pO2, mmHg +Z,38 | 77.64 ± 14.69 +Z,38 | 83.11 ± 19.77 +Z,38 | <0.047 +Z,38 |
| HCO3, +Z,38 | 23.96 ± 5.20 +Z,38 | 25.16 ± 4.08 +Z,38 | 0.114 +Z,38 |
| BE, +Z,38 | −0.26 ± 5.67 +Z,38 | 1.47 ± 3.35 +Z,38 | <0.018 +Z,38 |
| O2CT, +Z,38 | 14.74 ± 3.58 +Z,38 | 16.36 ± 3.26 +Z,38 | <0.004 +Z,38 |
| O2SAT, mmHg +Z,38 | 95.88 ± 2.85 +Z,38 | 96.75 ± 2.03 +Z,38 | <0.026 +Z,38 |
| TCO2, +Z,38 | 25.06 ± 5.46 +Z,38 | 26.33 ± 4.36 +Z,38 | 0.114 +Z,38 |
| Hb, +Z,38 | 11.62 ± 2.48 +Z,38 | 12.43 ± 2.27 +Z,38 | <0.035 +Z,38 |
| HCT, +Z,38 | 35.84 ± 7.12 +Z,38 | 37.75 ± 6.53 +Z,38 | 0.083 +Z,38 |
| CRP, +Z,38 | 1.77 ± 2.12 +Z,38 | 4.15 ± 6.08 +Z,38 | <0.002 +Z,38 |
| Pro BNP, +Z,38 | 11,720.87 ± 12,416.65 +Z,38 | 2,133.80 ± 4,649.93 +Z,38 | <0.000 +Z,38 |
| Troponin I, +Z,38 | 0.42 ± 1.20 +Z,38 | 0.11 ± 0.20 +Z,38 | <0.017 +Z,38 |

(Where, A P value < 0.05 was considered significant. Abbreviations: CHF, patients with a congestive heart failure; Non-C.D., patients without a congestive heart failure; M, males F, females S.G., specific gravity; O.B., occult blood; WBC, white blood cell; RBC, red blood cell; Ep. Cell, epithelial cell; HGB(Hb), hemoglobin; HCT, hematocrit; MCV, mean corpuscular volume; MCH, mean corpuscular hemoglobin; PLT, platelet count; NEUT, neutrophil; LYMP, lymphocyte; MONO, monocyte; EOS, eosinophil; BASO, basophil; LUC, large unstained cell; MPV, mean platelet volume; APTT, activated partial thromboplastin time; PT, prothrombin time; Cl, chloride; LDH, lactate dehydrogenase; CK, creatine kinase; CK-MB, creatine kinase MB fraction Inorg. Phos., inorganic phosphorus; BUN, blood urea nitrogen; Bilirubin(T), total bilirubin; Bilirubin(D), direct bilirubin; ALP, alkaline phosphatase; AST, aspartate aminotransferase; ALT, alanine aminotransferase; Ca2+, actual calcium; Mg2+, magnesium; ABGA, arterial blood gas analysis; O2CT, oxygen content; O2SAT, oxyhemoglobin saturation; TCO2, total carbon dioxide; CRP, c-reactive protein.) [symbol]
indicates data missing or illegible when filed

The following Table 4 shows a list and frequency of significance check items determined in the steps 1 to 4 of the significance parameter extraction method according to this invention for Train 1 to Train 10 (10-fold cross verification) in FIG. 1 (in a case where values of check items are converted into two nominal values).

TABLE 4

| | | | | | | | | | | | Fold | |
|---|---|---|---|---|---|---|---|---|---|---|---|---|
| Selected feature lists | | Fold 1 | Fold 2 | Fold 3 | Fold 4 | Fold 5 | Fold 6 | Fold 7 | Fold 8 | Fold 9 | 10 | Prequency |
| Urinalysis | pH | | | | | | | | ◯ | | | 1 |
| Common | WBC | | | | | | | | ◯ | | | 1 |
| Blood Cell | RBC | | | | | ◯ | | | | | | 1 |
| & Differential | HGB | ◯ | ◯ | | | | | | | | | 2 |
| Count | MCV | | | ◯ | | ◯ | ◯ | | | | | 3 |
| | MCH | | | | ◯ | ◯ | | ◯ | | ◯ | ◯ | 5 |
| | MCHC | | | ◯ | ◯ | | ◯ | ◯ | | ◯ | | 5 |
| | PLT | ◯ | ◯ | | | | | | | | | 2 |
| | NEUT | ◯ | | | | | | | ◯ | | | 2 |
| | MONO | ◯ | | | ◯ | | ◯ | ◯ | | | | 4 |
| | EOS | ◯ | ◯ | ◯ | ◯ | ◯ | ◯ | ◯ | ◯ | ◯ | ◯ | 10 |
| | MPV | | | ◯ | | | ◯ | | | ◯ | | 3 |
| Routine | Calcium | | | | | | | | ◯ | | | 1 |
| Admission | Inorganic Phosphorus | | | ◯ | | | | | | | | 1 |
| | Glucose | | ◯ | | | | | | | | | 1 |
| | BUN | ◯ | ◯ | | ◯ | | ◯ | ◯ | | | | 5 |
| | Cholesterol | | | | ◯ | | | ◯ | | | | 2 |
| | Bilirubin(T) | | | | | | | | | | ◯ | 1 |
| | Bilirubin(D) | ◯ | ◯ | | ◯ | ◯ | ◯ | ◯ | | ◯ | ◯ | 8 |
| | ALP | ◯ | ◯ | | | ◯ | | | | | | 3 |
| | ALT | | | ◯ | | | | | | | | 1 |
| Serum | K | | ◯ | | | | | | | | | 1 |
| Electrolytes | Cl | | | | | | | | ◯ | ◯ | | 2 |
| Arterial Blood Gas | BE | | | | | | | | ◯ | | | 1 |
| Analysis | O2SAT | | | ◯ | ◯ | ◯ | ◯ | ◯ | | ◯ | ◯ | 7 |
| | TCO2 | | | | | | | | | | ◯ | 1 |

| | | | | | | | | | | | |
|---|---|---|---|---|---|---|---|---|---|---|---|
| PT1 | | | | | | | | | ◯ | | 1 |
| Fibrinogen | | | | | | | | ◯ | | | 1 |
| LDH | | | ◯ | | ◯ | | | | | | 2 |
| Amylase | | | | | ◯ | | | | | ◯ | 2 |
| Troponin I | ◯ | ◯ | ◯ | ◯ | ◯ | ◯ | ◯ | ◯ | ◯ | ◯ | 10 |
| CK-MB | | | | | | | | | ◯ | 1 | |
| Length of Feature Lists | 9 | 9 | 9 | 9 | 10 | 9 | 9 | 9 | 9 | 9 | 91 |

In Table 4, Fold 1 to Fold 10 represent Train 1 to Tran 10, respectively, and ‘0’ represents selected check items when the steps 1 to 4 are performed in each fold. For example, Fold 1 (Train 1) means that {HGB, PLT, NEUT, MONO, EOS, BUN, Direct Bilirubin, Troponin I} are selected as significance check items. ‘Length of feature lists’ means the number of significance check items selected in each Fold and ‘Frequencies’ means the total number of frequencies selected in each check item for Fold 1 to Fold 10.

The following Table 5 shows a list and frequency of significance check items determined in the steps 1 to 4 of the significance parameter extraction method according to this invention for Train 1 to Train 10 (10-fold cross verification) in FIG. 1 (in a case where values of check items are converted into four nominal values).

TABLE 5

| | | | | | | | | | | | Fold | |
|---|---|---|---|---|---|---|---|---|---|---|---|---|
| Selected feature lists | | Fold 1 | Fold 2 | Fold 3 | Fold 4 | Fold 5 | Fold 6 | Fold 7 | Fold 8 | Fold 9 | 10 | Prequency |
| Urinalysis | RBC | ◯ | ◯ | | ◯ | ◯ | | | ◯ | | | 5 |
| Common | WBC | | | | | | | | | ◯ | | 1 |
| Blood Cell | RBC | | ◯ | | | | | | | | | 1 |
| & Differential | HGB | | | | | | | ◯ | | | | 1 |
| Count | HCT | ◯ | | | ◯ | ◯ | ◯ | ◯ | ◯ | | ◯ | 7 |
| | MCV | | | | ◯ | | | | ◯ | | | 2 |
| | HCHC | ◯ | | ◯ | | ◯ | ◯ | | ◯ | | ◯ | 6 |
| | NEUT | | | ◯ | | | | | | | | 1 |
| | MONO | | | | | | | | | ◯ | | 1 |
| | EOS | ◯ | | | | | ◯ | | ◯ | ◯ | ◯ | 5 |
| | MPV | | | | | | | ◯ | | | | 1 |
| | Inorganic Phosphorus | ◯ | | | | ◯ | | | | | | 2 |
| | Cholesterol | | | | ◯ | | | | | | | 1 |
| | Bilirubin(T) | | | | | | | | | | ◯ | 1 |
| | AST | | | | | | | ◯ | | | | 1 |
| Serum | Na | | | ◯ | ◯ | | | | | ◯ | | 3 |
| Electrolytes | K | ◯ | | | | | | | | | | 1 |
| | Cl | | ◯ | | | | | | ◯ | | | 2 |
| Arterial Blood Gas | pH | | ◯ | | ◯ | ◯ | ◯ | | | | | 4 |
| Analysis | BE | | | | | | | | | ◯ | | 1 |
| | O2SAT | | ◯ | ◯ | | ◯ | | | | | | 3 |
| | TCO2 | | | | | | | | | | ◯ | 1 |

| | | | | | | | | | | | |
|---|---|---|---|---|---|---|---|---|---|---|---|
| APTT | | | ◯ | | | | ◯ | | | | 2 |
| Fibrinogen | | | | | | | | ◯ | | | 1 |
| LDH | | | | | | | | | ◯ | | 1 |
| Lipase | | ◯ | | | | | | | | | 1 |
| Pro-BNP | ◯ | ◯ | ◯ | ◯ | ◯ | ◯ | ◯ | ◯ | ◯ | ◯ | 10 |
| Ca²⁺ | | | ◯ | | | ◯ | ◯ | | | | 3 |
| Length of Feature Lists | 7 | 7 | 7 | 7 | 7 | 6 | 7 | 7 | 7 | 7 | 69 |

In this manner, in this invention, the clinical decision model for differential diagnosis of the group of congestive heart failure patients and the group of non-cardiac dyspneic patients is designed in consideration of all check items determined by one reference value (conversion into two nominal values) and two reference values (conversion into three nominal values) for the 10-fold cross verification).

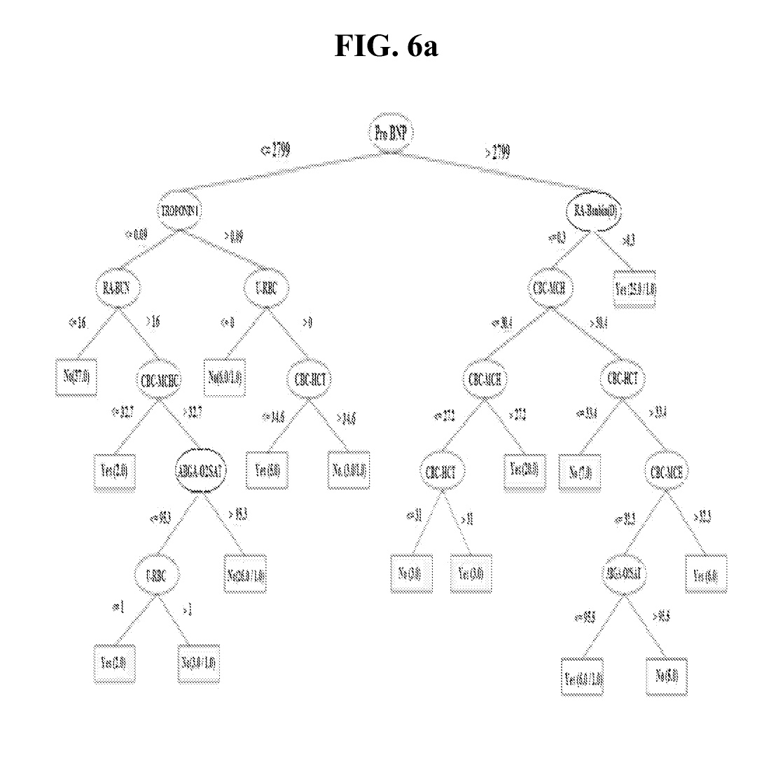

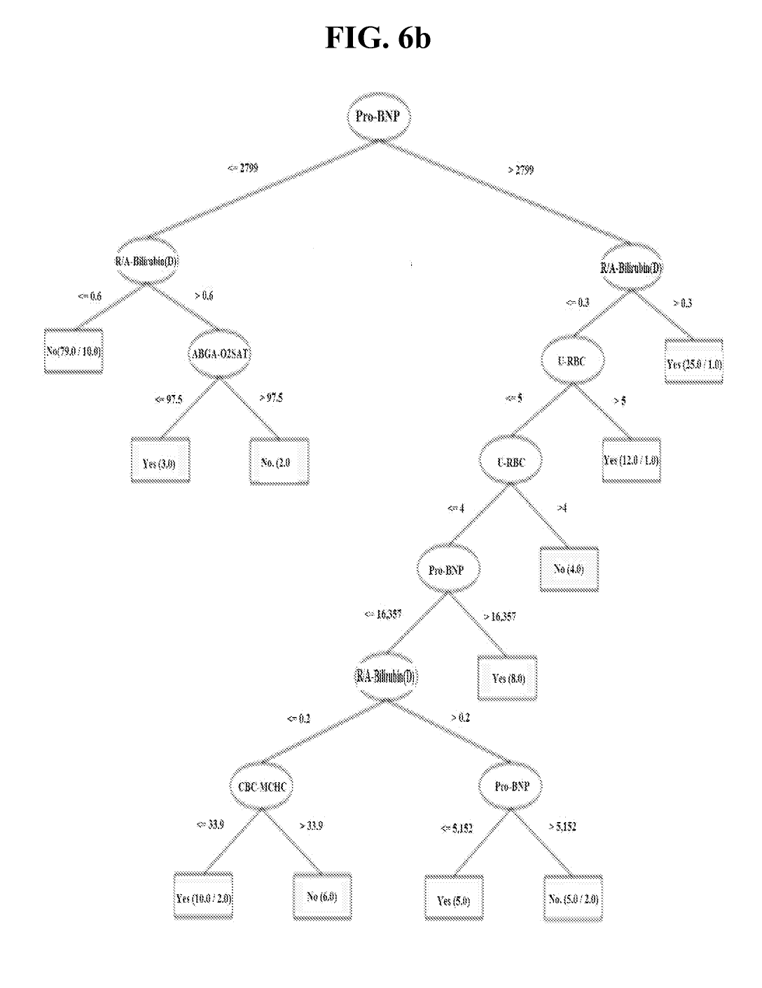

FIG. 6 is a model view showing an example of a decision model applied to the integrated clinical decision support system of the present invention and a conventional decision model. FIG. 6 shows a schematic view of a clinical decision model for differential diagnosis of the group of congestive heart failure patients and the group of non-cardiac dyspneic patients.

As shown in FIG. 6(a), an ‘elliptical node’ represents a check item and a ‘rectangular node’ represents a value of final decision (i.e., the group of congestive heart failure patients if YES, the group of non-cardiac dyspneic patients if NO). The above decision model corresponds to the ‘clinical decision support model (using decision tree)’ in FIG. 1.

FIG. 6(b) shows a model generated by a decision tree after multiple regression analysis in consideration of a convention stepwise characteristic selection technique. In the embodiment of the invention, evaluation of performance of the clinical decision model for differential diagnosis of the group of congestive heart failure patients is performed by an ‘evaluation’ module as shown in FIG. 1.

The following Table 6 shows a comparison of results of performance evaluation between a conventional decision model and the clinical decision model applied to the integrated clinical decision support system of this embodiment.

TABLE 6

| | Decision model | Decision model |
|---|---|---|
| | designed by the | after multiple |
| Evaluation measure | present invention | regression analysis |
| Average sensitivity | 72% | 68% |
| Average specificity | 74% | 74% |
| Geometric mean | 73% | 71% |
| Average knowledge number | 16 | 11 |

In Table 6, the average knowledge number represents the number of shadowed rectangular nodes (leaf nodes) in FIG. 6 and can be used to derive clinical knowledge for differential diagnosis of the group of congestive heart failure patients as follows.

### Example 1

### Clinical Knowledge Derived from the Decision Model Designed by the Present Invention

If Pro BNP is <=2,799 and Troponin I is <=0.09 and BUN is <=16

Then Diagnosis is No (Support=37)

If Pro BNP is >2,799 and Bilirubin(D) is >0.3

Then Diagnosis is 150 (Support=25/1)*

A value ‘25’ represents the number of patients correctly classified by I50 (True Negative (TN) and a value ‘1’ represents the number of patients incorrectly classified by No (False Positive (FP)).

### Example 2

### Clinical Knowledge Derived from the Decision Model After Multiple Regression Analysis

If Pro BNP is <=2,799 and Bilirubin(D) is<=0.6

Then Diagnosis is No (Support=79/10)

If Pro BNP is >2,799 and Bilirubin(D) is >0.3

Then Diagnosis is 150 (Support=25/1)

In Table 6, the geometric means represents the mean of results evaluated by the following equation in each fold during the 10-fold cross verification. The average sensitivity and the average specificity means a sensitivity evaluation measure and a specificity evaluation measure, respectively. From Table 6, it can be seen that the decision model designed by the present invention has high precision and reliability with high average sensitivity and average knowledge number.

In this manner, in the integrated clinical decision support system of this invention, the disease data base 20 (or disease Data Mart) defined by clinical specialists is constructed from a plurality of clinical databases 10 in the hospital information system (HIS), and the clinical decision support model is designed through the clinical decision module 30 of this invention using disease clinical data from the disease DB 20.

Then, temporary knowledge generated from the clinical decision support module 30, along with clinical decision support information, is stored in the knowledge database 60, and the clinical decision support synthetic information generated through the knowledge database 60 is obtained in the application interface module 70.

In addition, a core knowledge repository database 50 may also store the information generated in the clinical decision support module 30 and core knowledge obtained based on clinical information decided by clinical specialists 40. In this manner, extraction of additional core knowledge by the clinical specialists provides higher reliability.

Although a few exemplary embodiments have been shown and described, it will be appreciated by those skilled in the art that adaptations and changes may be made in these exemplary embodiments without departing from the spirit and scope of the invention, the scope of which is defined in the appended claims and their equivalents.

### INDUSTRIAL APPLICABILITY

In this manner, by integrating the clinical decision model for a particular disease with the clinical decision model partially designed for similar diseases and building a database for clinical knowledge, it is possible to construct an integrated clinical decision support system for differential diagnosis of similar diseases.

In addition, since the temporary knowledge database in FIG. 5 is additionally considered, it is possible to provide additional functions to infer clinical cases in addition to the core knowledge repository database verified by clinical specialists.

In addition, in that the integrated clinical decision support system can be effectively used to create education and learning contents for interns and residents for each department in a hospital, there is a great advantage that decision on new clinical cases or instances of diseases can be utilized as clinical tools to allow ‘evidence-based medical decision’ by synthetically utilizing actual clinical result information accumulated for years in the hospital information system (HIS) without being confined in a way of thinking based on textbook or documents.

1. A significance parameter extraction method for differential diagnosis of abnormal diseases based on entropy rough approximation technology, comprising the steps of:
(a) calculating clinical reference values from two different groups of clinical data extracted from a database storing a plurality of clinical data for each check item using an entropy maximization measure;
(b) evaluating a clinical difference between the two different groups of clinical data and extracting candidate check items;
(c) based on a reference value of a check item calculated from one of the groups of clinical data, converting attribute values of the check item into nominal attribute values; and
(d) extracting significance parameters for differential diagnosis from the candidate check items extracted in the step (b).

2. The significance parameter extraction method according to claim 1, wherein the two different groups of clinical data include:
a group having one disease and a group having another disease; or
a group having one disease and a group having other diseases.

3. The significance parameter extraction method according to claim 1, wherein the entropy maximization measure is calculated by:
$$Maximize to H ( T ) = {H}_{R 1} ( T ) + {H}_{R 2} ( T ) , \\ where {H}_{R 1} ( T ) = - {\sum }_{g = {a}_{min}}^{T} {P}_{R 1} ( g ) \cdot log {P}_{R 1} ( g ) , \\ {H}_{R 2} ( T ) = - {\sum }_{g = T + 1}^{{a}_{max}} {P}_{R 2} ( g ) \cdot log {P}_{R 2} ( g ) , \\ P ( g ) = {\sum }_{i = {a}_{min}}^{g} p ( i )$$
where, P(g) represents a cumulative probability value in a domain range, and H_{R1}(T) and H_{R2}(T) represent threshold values, that is, entropies of two regions R1 and R2 when a reference value of the corresponding check item is T, where H(T) represents the sum of entropies.

4. The significance parameter extraction method according to claim 1, wherein the step (b) includes:
in case of a single reference value, extracting cases where reference values of the two different groups of clinical data for one check item are different, as candidate check items; and
in case of two reference values, extracting cases where one range of reference values is not included in another range of reference values, as candidate check items.

5. The significance parameter extraction method according to claim 1, wherein the step (c) includes:
in case of a single reference value, converting values of check items of two regions into nominal values based on the single reference value; and
in case of two reference values, converting values of check items of three regions into nominal values based on the two reference values.

6. The significance parameter extraction method according to claim 1, wherein the step (d) includes the steps of:
generating a decision table to be converted into the extracted candidate check items and the nominal values for each check item;
generating a discernibility matrix based on the decision table; and
extracting significance parameters for differential diagnosis by calculating a discernibility function from the discernibility matrix.

7. The significance parameter extraction method according to claim 6, wherein the discernibility matrix is generated by:
(cᵢⱼ)=aεA:a(xᵢ)≠a(xⱼ),∃i,j, for dᵢ≠ⱼ
where, A means the total set of input variables representing check items, and a means any element in the total set of input variables, xᵢ represents an i-th case, dᵢ represents an i-th output attribute value indicating a disease, cᵢⱼ means input variables having a difference in attribute value between two different cases, and N represents the total number of cases.

8. The significance parameter extraction method according to claim 7, wherein the discernibility function is expressed by:
$$f ( A ) = {\prod }_{( x , y ) ∈ {U}^{2}} ( \sum δ ( x , y ) : ( x , y ) ∈ {U}^{2} and δ ( x , y ) \neq φ )$$
where, Σδ(x,y) means an OR operation between attribute values included in (x,y) elements, and
$${\prod }_{( x , y ) ∈ {U}^{2}} ( \cdot )$$
means an AND operation between different elements in a corresponding case.

9. The significance parameter extraction method according to claim 7, wherein at least one nominal value in the decision table is null, and unknown values can have all corresponding values.

10. An integrated clinical decision support system comprising:
a clinical information database including clinical data for each of a plurality of check items;
a database which stores disease information defined by clinical specialists from the clinical data;
a clinical decision support module which uses a method according to claim 1;
a knowledge database which stores temporary knowledge generated from the clinical decision support module, including clinical decision support information; and
an application interface module which acquires clinical decision support synthetic information generated through the knowledge database.

11. The integrated clinical decision support system according to claim 10, further comprising a core knowledge repository database which stores the information generated in the clinical decision support module and core knowledge obtained based on clinical information decided by clinical specialists.

12. The integrated clinical decision support system according to claim 10, wherein the clinical decision support module includes a significance parameter extraction module using a method according to claim 1, and a clinical decision model design module.

13. The integrated clinical decision support system according to claim 12, wherein the clinical decision model design module is designed to have a tree structure with application of all check items, which are determined by one reference value or two reference values applied to the significance parameter extraction method, to N groups of experiments and controls data collected by N random samplings from the clinical information database.
